(19) United States
(12) Patent Application Publication
(10) Pub. No.: US 2023/0126497 A1
(43) Pub. Date: Apr. 27, 2023

(54) TRACKING TIME-BASED CONDITIONS RELATIVE TO EVENTS FOR SECURE ELECTRONIC DOCUMENT AGREEMENTS

(71) Applicant: DocuSign, Inc., San Francisco, CA (US)

(72) Inventors: Richard Tkachuk, Bellevue, WA (US); Daniel Charles Selman, Winchester (GB); Matthew Roberts, South Moreton (GB); Jason Lee, Redmond, WA (US); Nikhil M. Patel, Kirkland, WA (US); Haitao Song, Sammamish, WA (US)

(21) Appl. No.: 17/510,917

(22) Filed: Oct. 26, 2021

(51) Int. Cl. G06F 16/93; G06F 9/54; G06F 40/247; H04L 29/08; G06K 9/62; G06N 20/00

(52) U.S. Cl. CPC G06F 16/93; G06F 9/542; G06F 40/247; H04L 67/12; G06K 9/6256; G06N 20/00

(57) ABSTRACT

A document management system accesses a document signed by one or more parties. The document may indicate one or more events that the parties contracted to occur in relation to the time-based conditions. The document management system inputs the document to a machine-learned model configured to identify one or more time-based conditions indicated in the document. The document management system receives one or more time-based conditions from the machine-learned model. For each time-based condition, the document management system identifies a respective database that catalogs event information corresponding to the time-based condition. The document management system obtains the event information related to the time-based condition and determines whether the time-based condition has been met based on the event information. For each time-based condition that has not been met, the document management system transmits an alert to one or more of the parties.

### BACKGROUND

A document management system can enable parties to sign agreements stipulating duties between the parties to one another. The duties may be related to an exchange of goods and/or services that are subject to time-based conditions indicated in the agreement. Traditionally, to determine whether an agreement has been fully executed, an external operator may monitor events associated with time-based conditions. If a time-based condition was not met, the external operator would need to consult the agreement to determine how the signing parties want to proceed. The external operator may additionally need to contact the signing parties or manually engage a specific workflow indicated in the agreement. For example, an agreement may indicate that a first party will ship a package for a second party. If an external operator determines that the package did not arrive within a set amount of time indicated in the agreement, the external operator may need to read the agreement to determine that the second party wanted to be notified and reimbursed if the package was late.

Further, automatically determining whether a document has been fully executed via a machine-learned model is difficult due to the complexity of training the machine-learned model. For instance, manually labeling data to train the machine-learned model with is arduous for an external operator and may still result in a limited set of training data, rendering predictions inaccurate. Thus, to streamline the processes outlined in agreements, a document management system that employs a machine-learned model trained on a robust set of data to detect time-based conditions is necessary.

### SUMMARY

The following disclosure describes a document management system that tracks events specified for agreements relative to one or more time-based conditions. In particular, the document management system accesses an agreement, signed by a set of parties, indicating a set of conditions for a valid agreement. For the conditions to be met, one or more events may occur, and the document management system may capture event information about these events via alerts from client devices and/or sensor data. The document management system determines time-based conditions indicated the agreement, where a time-based condition describes an amount of time in which an event needs to occur based on the agreement. The document management system obtains event information related to each time-based condition and determines, based on the event information, whether the time-based condition was met. Responsive to the time-based condition not being met, the document management system may transmit alerts to one or more of the parties of the agreement that the agreement has been breached. Responsive to each time-based condition being met, the document management system may transmit alerts to the one or more parties indicating that the agreement has been completed.

In some embodiments, the document management system accesses a document signed by one or more parties. The document may indicate one or more events that the parties contracted to occur in relation to the time-based conditions. The document management system inputs the document to a machine-learned model configured to identify one or more time-based conditions indicated in the document. The document management system receives one or more time-based conditions from the machine-learned model. For each time-based condition, the document management system identifies a respective database that catalogs event information corresponding to the time-based condition. The document management system obtains the event information related to the time-based condition and determines whether the time-based condition has been met based on the event information. For each time-based condition that has not been met, the document management system transmits an alert to one or more of the parties.

The machine-learned model may be trained to detect time-based conditions on a set of training data determined by the document management system. The document management system retrieves one or more historical documents and segments the historical documents into one or more clauses. The document management system sends the clauses for labeling by an external operator and adds each labeled clause to the set of training data. The document management system jitters each labeled clause to determine one or more alternate clauses labeled with the same label and adds the labeled alternate clause to the set of training data. The document management system trains the machine-learned model on the set of training data.

### BRIEF DESCRIPTION OF THE DRAWINGS

FIG. 1 is a block diagram of a system environment in which a document management system operates, in accordance with an embodiment.

FIG. 2 is a block diagram of the document management system, in accordance with an embodiment.

FIG. 3 illustrates a process of transmitting alerts based on time-based conditions not being met, in accordance with an embodiment.

FIG. 4 illustrates an example timeline of sending an alert based on a time-based condition, in accordance with one embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

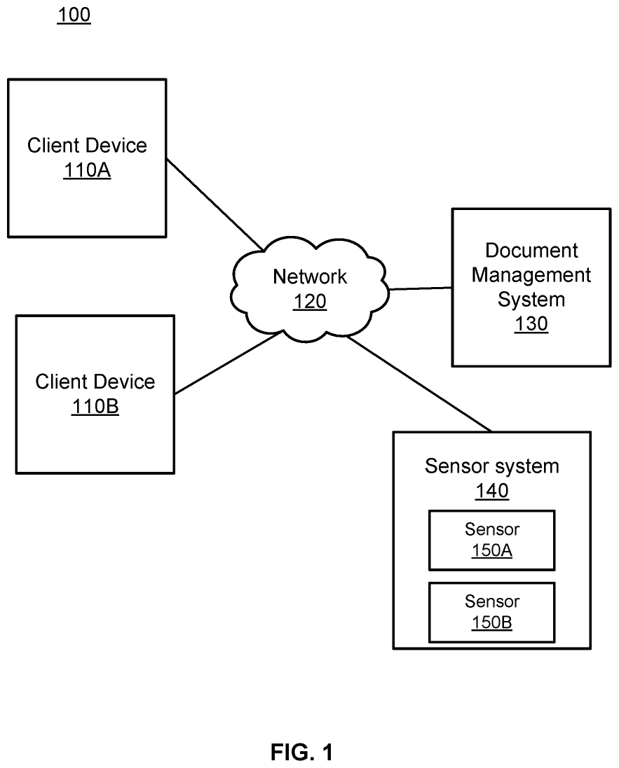

FIG. 1 is a block diagram of a system environment 100 in which the document management system operates. The system environment 100 shown by FIG. 1 includes the document management system 130, client devices 110, and a sensor system 140. The system environment 100 may have alternative configurations than shown in FIG. 1, including for example different, fewer, or additional components. For example, additional or fewer client devices 110 or sensor systems 140 may be communicatively coupled via the network 120 to the document management system 130. As another example, the document management system 130 may be communicatively coupled with a remote database that stores data for the client devices 110 or sensor system 140. As referred to herein, a “document” is an electronic document such as an invoice, agreement, sales order, or other contract sent through a communications network (e.g., the network 120). A secure document cannot be changed once executed by one or more parties and has a fixed format that is auditable.

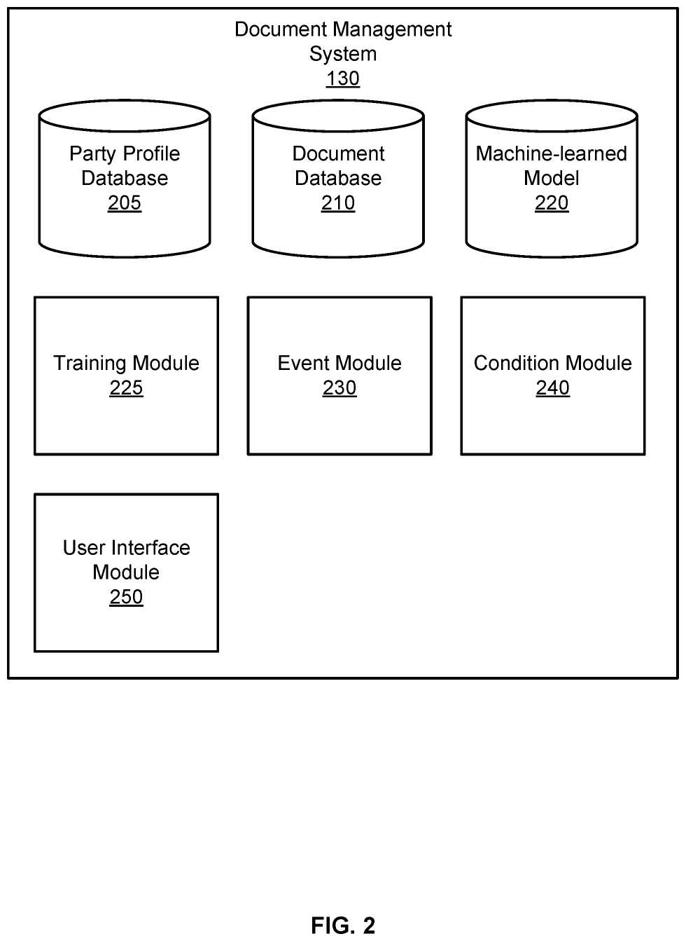

The system environment 100 described herein can be implemented within the document management system 130, a document execution system, or any type of digital transaction management platform. It should be noted that although description may be limited in certain contexts to a particular environment, this is for the purposes of simplicity only, and in practice the principles described herein can apply more broadly to the context of any digital transaction management platform. Examples can include but are not limited to online signature systems, document creation and management systems, collaborative document and workspace systems, online workflow management systems, multi-party communication and interaction platforms, social networking systems, marketplace and financial transaction management systems, or any suitable digital transaction management platform. The document management system 130 is further described in relation to FIG. 2.

The network 120 may serve to communicatively couple the client devices 110, sensor system 140, and the document management system 130. In some embodiments, the network 120 includes any combination of local area and/or wide area networks, using wired and/or wireless communication systems. The network 120 may use standard communications technologies and/or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 105 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network may be represented using any suitable format, such as hypertext markup language (HTML) or extensible markup language (XML). In some embodiments, all or some of the communication links of the network 120 may be encrypted using any suitable technique or techniques.

The client devices 110 use the document management system 130 to communicate documents to or coordinate document activity with other client devices 110. Each client device 110 may be a computing device capable of receiving user input and transmitting and/or receiving data via the network 105. In some embodiments, the client devices 110 may be conventional computer systems, such as a desktops or a laptop computers. Alternatively, the client devices 110 may be devices having computer functionality, such as a personal digital assistant (PDA), a mobile telephone, a smartphone, or another suitable device. The client devices 110 are each configured to communicate with the document management system 130 via the network 105, for example using a native application executed by the client device 110 and provides functionality of the document management system 130, or through an application programming interface (API) running on a native operating system of the computing device, such as IOS® or ANDROID™.

The sensor system 140 comprises one or more sensors 150 configured within an environment. The sensor system 140 transmits sensor data captured by the sensors 150 to the document management system 130 and/or client devices 110 via the network 120. The sensors 150 of the sensor system 140 are configured to capture signals (e.g., sensor data) describing the environment. The sensors 150 may include one or more of a pressure sensor, a temperature sensor, a radio-frequency identification (RFID) sensor, an RFID tag, a light sensor, a humidity sensor, and a Global Positioning System (GPS), among other suitable sensors.

The sensors 150 of the sensor system 140 may be configured to one or more components of the environment. For example, the sensors 150 may be a humidity sensor 150A and a temperature sensor 150B attached to the inside of a freight container. The sensors 150 may periodically measure changes in humidity and temperature within the freight container as the freight container is being shipped from one place to another. The document management system 130 may receive sensor data from each of the humidity sensor 150A and temperature sensor 150B through the sensor system 140 or separately from each sensor 150. In another example, the sensor system 140 may include a GPS attached to a truck that is travelling across the country. The GPS may continuously track the position of the truck on its route, and the sensor system 140 may send the position of the truck to one or more client devices 110 and/or the document management system 130.

### Document Management System

FIG. 2 is a block diagram of the document management system 130, in accordance with an embodiment. The document management system 130 includes a party profile database 205, a document database 210, a machine-learned model 220, a training module 225, an event module 230, a condition module 240, and a user interface module 250. The modules and databases illustrated in FIG. 2 are merely exemplary, and other embodiments of the document management system 130 may include additional, fewer, and/or different components. For example, in some embodiments, at least one of the party profile database 205, a document database 210, and the machine-learned model 220 may be stored remotely and may be accessible through the network 105.

The party profile database 205 stores characteristic information of parties (e.g., entities, such as users or corporations, that use client devices 110) connected to the document management system 130 and activity history of the parties as captured via the client devices 110. A party may be a single user or a plurality of users that are connected within a domain (e.g., a corporate entity). As referred to herein, “characteristic information” of a party represents characteristics of the party and activities performed by the party within the document management system 130. Characteristics may include type of industry associated with the party (e.g., financial, technology, healthcare), number and identity of accounts associated with the party (e.g., accounts of employees and/or accounts in the party, where each account is an email address, domain name, etc.), type and number of parties with which the party has interacted in the past, types of documents that the party has sent or received in the past, applications used by the party to access documents, geographic location of the party, security measures associated with the party, interne protocol (IP) addresses used by client devices 110 of the party, hardware attributes of computing devices of the party, or any other suitable characteristics of a party that is not directly related to the document management system 130. Activity history may include data associated with activities previously performed by the party such as type of action performed, date and time at which actions were performed, identities of documents on which the actions were performed, or other suitable data regarding previous activity performed by the party.

The document database 210 stores documents that are sent or received by client devices 110 connected to the document management system 130. A document may be an agreement, invoice, sales order, or other contract and may include text data, image data, spreadsheet data, or any other type of data (henceforth referred to as “document information”). The document information of a document may describe a set of conditions to be met for a valid agreement, which may be described by one or more events. Each event occurs in relation to the conditions of the document. For example, if a document indicates that a first party will transport pineapples to Amsterdam for a second party, the document may be associated with the events of: the pineapples being packed for shipping, the pineapples reaching a port in São Paulo, the pineapples reaching a port in Amsterdam, the pineapples reaching a warehouse of the second party by a certain time, and the pineapples only experiencing temperatures below 75 degrees Fahrenheit during their journey. In some embodiments, the events may relate to tolerating and tracking minor deviations in sensor data captured in relation to the document. For example, the document may include the event of pineapples reaching a temperature above 75 degrees Fahrenheit for no more than 60 consecutive seconds. The document database 210 stores the events related to each document and may, in some embodiments, store each event in relation to specific document information of the document. The document database 210 may further store event information related to each event, where the event information describes real-world occurrences that have happened related to an event. The event information may be one or more of notifications and alerts received from client devices, sensor data captured by one or more sensors 150 related to the document, and any other data describing events. The event information may be stored in the document database 210 by the event module 230 or, in some embodiments, the event information may be stored in separate databases corresponding to an associated party or document.

The document database 210 may also store metadata associated with a document such as document type, content of the document (e.g., certain keywords within the document), types of tasks associated with the document, creator of the document, access privileges, date of creation, file size, date of transmission, date of request completion, place of creation, template associated with document, tags and categories, file name, identifiers of parties that signed or are otherwise associated with the document, and any other aspect of the document. The metadata may also include time-based conditions indicated in each document. A time-based condition describes an amount of time in which an event is meant to occur, as indicated in the document. The time-based conditions are identified using the machine-learned model 220, as described further below.

The machine-learned model 220 is trained to identify one or more time-based conditions indicated in a document. Though described herein as detecting time-based conditions, in some embodiments, the machine-learned model 220 may identify any other suitable conditions indicated in the document. The machine-learned model 220 may be implemented using one or more of a variety of types of machine-learned models or trainable networks. For example, the machine-learned model 220 may use various machine learning techniques such as linear support vector machine (linear SVM), boosting for other algorithms (e.g., AdaBoost), neural networks, logistic regression, naive Bayes, memory-based learning, random forests, bagged trees, decision trees, boosted trees, boosted stumps, neural networks, or any suitable algorithms. Though referred to herein as a singular machine-learned model 220, in some embodiments, the machine-learned model 220 may be a plurality of machine-learned models that function together to identify time-based conditions.

The machine-learned model 220 is trained by the training module 225 on documents labeled with time-based conditions. In some embodiments, the machine-learned model 220 is trained using a training dataset including historical documents and/or clauses of historical documents labeled with time-based conditions. For example, the labeled historical documents may each be segmented into clauses, each clause labeled with a time-based condition indicated by the document information of clause. The training module 225 trains the machine-learned model 220 with the training dataset to learn patterns in the historical documents indicating time-based conditions and to output clauses or other portions of the document indicating a time-based condition. In some embodiments, the machine-learned model 220 is trained to output a probability that a clause indicates a time-based condition (e.g., 95% probability of the text “driver will not exceed 75 miles per hour while transporting pineapples from port to warehouse” indicating a time-based condition).

In some embodiments, the training module 225 creates a set of training data used to train the machine-learned model 220. The training module 225 may access one or more historical documents that each indicate agreements previously executed between parties. The training module 225 may segment each document into a set of clauses (e.g., by segmenting by punctuation). The training module 225 may transmit the set of clauses to the user interface module 250 for manual labeling by an external operator. In some embodiments, the training module 225 transmits the full document to the user interface module 250 for manual segmentation and labeling by an external operator.

The training module 225 receives the labeled clauses of each document from the user interface module 250 and creates deviations of each clause by jittering the clause. In some embodiments, the training module 225 jitters each clause by creating alternate clauses with one or more words each replaced with a synonym. In other embodiments, the training module 225 determining strengths of association between adjacent words in each clause based on sentence structure of the clause and producing alternate clauses with similar strengths of association between words. The training module 225 labels the alternate clauses with the same label as the originating clause and uses the labeled clauses and alternate clauses as a training set of the machine-learned model 220. In some embodiments, the training module 225 transmits the labeled alternate clauses to the user interface module 250 for presentation to an external moderator. The training module 225 may receive, from the user interface module 250, indications of alternate clauses that are mislabeled. The training module 225 may update the label of each alternate clause based on the indication.

In some embodiments, the training module 225 retrieves, from the document database 210, clauses associated with time-based conditions that were assessed by the condition module 240. The training module 225 sends the clauses each with an indication of whether or not the time-based condition of the clause was met to the user interface module 250 for presentation to an external operator. The training module 225 receives, from the user interface module 250, a correction for clauses where the external operator indicated that the condition module 240 improperly determined whether the time-based condition was met (e.g., the clause indicated that a time-based condition was not met, but an external operator confirms that the time-based condition was met). The training module 225 may label the clauses based on the correction. The The training module 225 adds the clauses labeled with corrections to the training data for training the machine-learned model 220 and retrains the machine-learned model 220 on the entire set of training data to reinforce the machine-learned model's 220 learning and prevent similar errors when used in the future. For example, a clause may indicate the time-based condition “manufacturing of widgets by Sunday” was not completed but receive a correction from the user interface module 250 that the time-based condition was completed “Saturday at noon,” along with corresponding sensor data showing that manufacturing was completed. The training module 225 labels the clause with the correction and sensor data and adds the labeled clause to the training data for retraining the machine-learned model 220.

The event module 230 receives and stores event information related to documents. For each document in the document database 210, the event module 230 receives information identifying one or more client devices 110 (or accounts of users) related to the document (e.g., upon creation or signature of the document by one or more parties). The client devices 110 may be associated with the parties that signed the document and events that the client devices receive and/or send alerts about (e.g., deliveries of goods, performance of services, actions taken by parties, etc.). For example, the client devices 110 may be associated with users who work together in a corporation or singular users that created the document together. The client devices 110 may also be associated with third parties related to the document. For example, if the document is a contract for shipping pineapples, a first client device 110 may associated with a user who wants the pineapples shipped, a second client device 110 may be associated with a user of a company shipping the pineapples, and a third client device 110 may be associated with a captain of a ship that will carry the pineapples who is contracted by the company provide shipping services.

For each document in the document database 210, the event module 230 may also receive information identifying one or more sensor systems 140 related to each document in the document database 210 (e.g., upon creation or signature of the document). Each sensor system 140 may include one or more sensors 150 configured to capture event information related to an event of the document. For example, a sensor system 140 may be coupled to a truck that is transporting goods across the United States. The sensor system 140 may include a GPS and speedometer attached to the truck for measuring position and speed of the truck as it transports the goods. In another example, a sensor system 140 may include a temperature sensor 150 and humidity sensor 150 coupled to the inside of a shipping container and capture sensor data describing the temperature and humidity goods in the shipping container experience during shipping.

In some embodiments, the event module 230 may apply one or more machine-learned models to the document to identify events, client devices, and/or sensors systems 140 related to the document. The one or more machine-learned models, which are separate from the machine-learned model 220, may be trained on historical documents labeled with events, client devices 110, sensors 150, and/or sensor systems 140 related to the documents. In other embodiments, the event module 230 may parse the document to match strings with names of parties in the party profile database 205 and names of sensors 150. The event module 230 matches identified parties to associated client devices 110 in the party profile database 205. The event module 230 stores the identifiers of the identified client devices 110, sensors 150, and/or sensor systems 140 in relation to the document in the document database 210.

The event module 230 receives event information from the identified client devices 110 and sensor systems 140. The event module 230 may receive the event information in real-time or may request the event information from the client devices 110 and sensor systems 140 periodically. The event information from client devices 110 may be notifications or alerts indicating status updates for events of a related document. For example, the event module 230 may receive an alert from a client device 110 that a meeting concluded at 3:33 PM or a notification that an order for a product has been electronically received by a production company. The event information may also include sensor data captured by sensors 150 of the sensor systems 140. For example, the event module 230 may receive sensor data captured in real-time from a temperature sensor and humidity sensor configured within a shipping container. The event information may be associated with a date and time of capture by the client devices 110 and/or sensors 150 and of receipt by the event module 230. The event module 230 stores the event information in the document database 210 in association with the document and identifiers of the client devices 110, sensors 150, sensor systems 140, and/or events described by the event information. In some embodiments, the event module 230 stores the event information in one or more additional databases incorporated into or connected to, via the network 120, the document management system 130. The databases may be organized by party, sensor system 140, type of sensor 150, document, or the like.

The condition module 240 detects whether or not time-based conditions in documents have been met. The condition module 240 accesses a document from the document database 210. In some embodiments, the condition module 240 accesses the document as it is created by one or more parties and dynamically identifies time-based conditions in the document as the one or more parties edit the document. In other embodiments, the condition module 240 accesses the document after the one or more parties have signed the document. The condition module 240 inputs the document to the machine-learned model 220 and receives one or more time-based conditions indicated in the document from the machine-learned model 220. Alternatively, in some embodiments, the condition module 240 receives, from the machine-learned model, a set of probabilities each associated with a clause from the document. The condition module 240 compares each probability to a condition threshold. Responsive to the probability exceeding the condition threshold, the condition module 240 determines that the document information indicates a time-based condition and stores the document information as metadata indicating the time-based condition in the document database 210.

In some embodiments, the condition module 240 may segment the document information into a plurality of categories and use the categorized document information as the time-based condition. The categories may include event, amount of time, and location. For example, document information about delivery of pineapples may be segmented into the event “pineapple delivery,” amount of time “Saturday, Oct. 20, 2021,” and location “warehouse” (or the GPS coordinates of the warehouse). In some embodiments, the condition module 240 may include a category of sensor systems 140 and sensors 150 related to the event. For example, the event “pineapple delivery” may be associated with a sensor system 140 including a temperature sensor 150 and humidity sensor 150 attached to a crate carrying the pineapples. The condition module 240 may store the segmented document information as the time-based condition in the document database 210. The condition module 240 monitors, in real-time, each time-based condition associated with the document for the amount of time to determine whether the time-based condition has been met within the amount of time.

For each time-based condition in the document, the condition module 240 identifies a database including event information related to the document. In some embodiments, the event information may be stored in the document database 210 with the document. In other embodiments, the event information may be stored across multiple databases within or external to the document management system 130. The condition module 240 determines a subset of the event information related to the time-based condition captured within the amount of time. The condition module 240 compares the document information about the time-based condition to identifiers of the client devices 110 (and related parties), sensors 150, and/or sensor systems 140 related to event information. In some embodiments, the condition module 240 may perform text matching on the document information of the time-based condition with identifiers of the client devices 110 (or associated parties), sensors 150, and/or sensor system 140. Responsive to one or more of the identifiers matching the document information, the condition module 240 may include that the event information in the subset. In other embodiments, the event information may be stored in an index related to the identifiers of the client devices 110, parties, sensors 150, sensor systems 140, and events described by the event information and the condition module 240 may query the index with segmented document information of the time-based condition to determine the subset of event information.

The condition module 240 determines, based on the subset, whether the time-based condition was met. The condition module 240 determines an event associated with the time-based condition (e.g., by parsing the document information to identify an action or accessing the event category of the time-based condition). The condition module 240 determines one or more instances that need to occur for the event to have occurred by parsing the document information associated with the time-based condition. For example, the condition module 240 may determine that for the event “pineapple delivery,” the event information needs to include a notification of delivery at a warehouse and a temperature sensor 150 coupled to the crate of pineapples may not detect a temperature above 90 degrees Fahrenheit.

The condition module 240 analyzes the subset to determine whether the one or more instances occurred within the amount of time of the time-based condition until the amount of time has ended. Responsive to each instance occurring within the amount of time, the condition module 240 determines that the time-based condition has been met. For example, if the condition module 240 may determine that the time-based condition for “pineapple delivery” was met if the highest temperature the temperature sensor 150 measured was 72 degrees Fahrenheit and the warehouse confirmed delivery of the pineapples. In another example, the condition module 240 may determine that a time-based condition for a “project” was met upon determining that a presentation was emailed to an associated party within an associated amount of time. Responsive to one or more instances not occurring within the amount of time, the condition module 240 determines that the time-based condition was not met. For example, the condition module 240 may compare sensor data from the event information to a threshold. Responsive to the sensor data misaligning with (e.g., is above or below) the threshold, the condition module 240 may determine that an associated time-based condition was not met. The condition module 240 monitors instances in relation to the time-based condition until the amount of time has ended (or another condition was met, such as a particular instance occurring). Responsive to the amount of time ending before the condition module 240 detects an instance occurring for the time-based condition, the condition module 240 determines that the time-based condition was not met. The condition module 240 stores an indication of whether each time-based condition as met in the document database 210 in association with the time-based condition (and an associated clause) and sends the indication to the user interface module 250.

The user interface module 250 generates interfaces for display on client devices 110. A user interface may include one or more documents and/or clauses with one or more interactive elements that a user may interact with via a client device 110. The user interface module 250 may receive, from the client device 110, indications of interactions with interactive elements, edits to the documents, signature information, labels for clauses and/or documents, corrections to time-based conditions that were assessed, and the like.

The user interface module 250 receives indications about time-based conditions from the condition module 240. For each indication, the user interface module 250 accesses the document database 210 to retrieves identifiers of the parties of an associated document and determines client devices 110 of the parties form the party profile database 205. The user interface module 250 determines one or more actions to take for the time-based condition based on whether the time-based condition was met and document information document. For instance, the user interface module 250 parses the document information to extract actions desired by the parties based on fulfillment (or not) of the time-based condition. Examples of actions include editing the document based on the time-based condition or associated sensor data, sending an alert to one or more of the parties, analyzing the event information for another condition of the document, transmitting payment to one or more parties, and the like. For example, the user interface module 250 may update a document to include how many miles a truck driver drove for a trucking company and automatically send the truck driver's client device 110 a payment based on the mileage. In some embodiments, the user interface module 250 may generate a user interface with the document and/or notifications describing the actions and send the user interface for presentation at client devices 110 of the parties. In other embodiments, the user interface module 250 transmits notifications of the actions to the client devices 110.

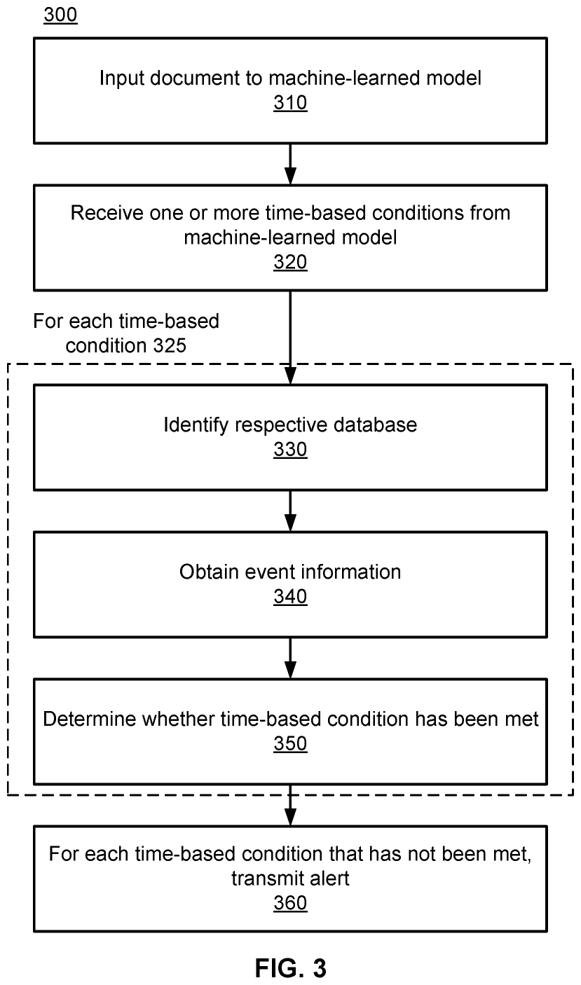

FIG. 3 illustrates a process 300 of transmitting alerts based on time-based conditions not being met, in accordance with an embodiment. Though reference is made to the modules of the document management server 130 for this process 300, the process 300 can be used by other online systems or mobile applications for transmitting alerts based on time-based conditions.

The condition module 240 accesses 310 a document signed by one or more parties from the document database 210. In some embodiments, the condition module 240 may access the document upon receiving an indication from the user interface module 250 that the document has been signed by all parties associated with the document. The condition module 240 inputs 310 the document to the machine-learned model 220, which is configured to identify time-based conditions from the document. The condition module 240 receives 320 one or more time-based conditions (e.g., clauses indicating time-based conditions) from the machine-learned model 220.

For each time-based condition 325, the condition module 240 identifies 330 a respective database cataloging events corresponding to the time-based condition. In some embodiments, the events may be stored in relation to the document and event information in the document database 210. In other embodiments, the condition module 240 may identify the respective database by identifying sensors associated with the document and receiving real-time sensor data as at least a portion of the event information. The condition module 240 obtains event information for the events and the condition module 240 determines 350 whether the time-based condition has been met based on the event information. For example, the condition module 240 may compare a time an alert of the event information was received to an amount of time of the time-based condition. Responsive to the alert being received within of the amount of time, the condition module 240 may determine that the time-based condition has been met. Responsive to the alert not being received within the amount of time, the condition module 240 may determine that the time-based condition has not been met. In another example, the condition module 240 may compare sensor data captured during the amount of time of the time-based condition to a threshold. Responsive to the sensor data misaligning with the threshold, the condition module 240 may determine that the time-based condition has not been met.

For each time-based condition that has not been met, the condition module 240 sends an indication to the user interface module 250 to transmit 360 an alert to one or more of the parties of the document. For example, the user interface module 250 may transmit an alert, via a user interface of a client device 110 of a first party, that indicates that the second party did not fulfill its contractual obligations of the document (e.g., the event did not occur within the amount of time). In some embodiments, the condition module 240 may also send indications to the user interface module 250 when a time-based condition has been met and store an indication that the time-based condition was met in the document database 210 with the document. The user interface module 250 may send an alert to client devices 110 of the parties to the document indicating that related event occurred within terms of the document. In some embodiments, responsive to all of the time-based conditions related to a document being met, the user interface module 250 may send an alert to the client devices 110 of the parties indicating that the events of the documents have been completed.

It is appreciated that although FIG. 3 illustrates a number of interactions according to one embodiment, the precise interactions and/or order of interactions may vary in different embodiments. For example, in some embodiments, the respective database may also include signature information (e.g., signatures by one or more parties) for the document and shipping updates related to the document. In other embodiments, the process 300 may include the training module 225 accessing historical documents with portions labeled with events and other event information. The training module 225 may train the machine-learned model 220 on the labeled historical documents. Further, in some embodiments, the document may be an agreement or contract between the parties.

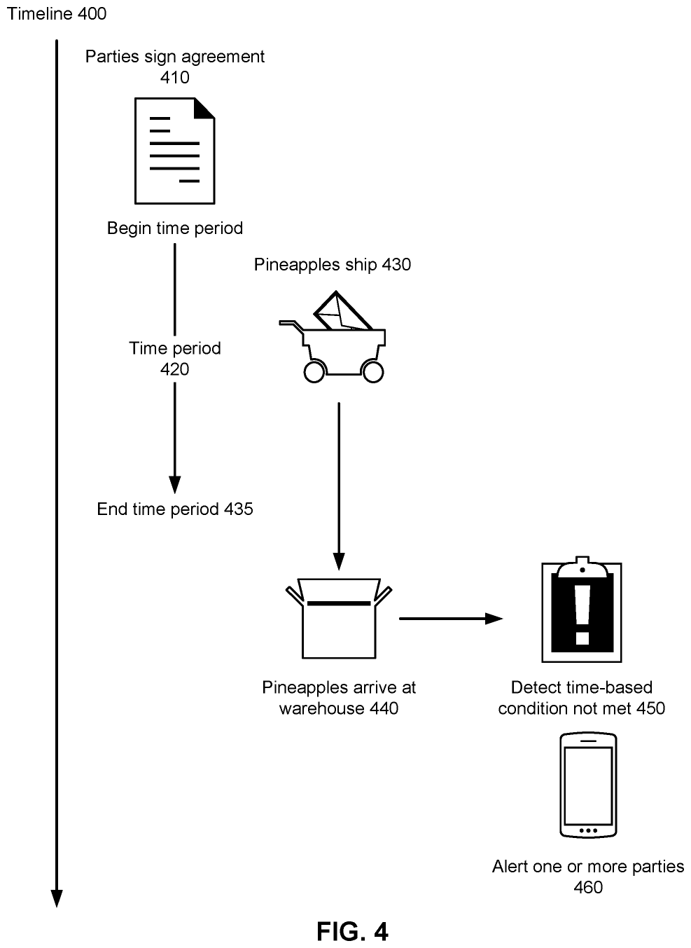

FIG. 4 illustrates an example timeline 400 of sending an alert based on a time-based condition, in accordance with one embodiment. In example timeline 400, a set of parties sign 410 an agreement via the document management system 130. The agreement may stipulate that a first party has an amount of time of 20 days from the signing of the agreement to ship pineapples to a warehouse associated with the second party. The document management system 130 detects the event “pineapple delivery completion” associated with the amount of time of “20 days from signature” as a time-based condition indicated in the agreement. Two days after the agreement is signed 410, the first party ships 430 the pineapples.

The pineapples arrive 440 at the warehouse after the amount of time ends 435. The document management system 130 receives an indication from a client device 110 associated with the first party that the pineapples have arrived at the warehouse and detects 450 that the time-based condition was not met. Based on this, the document management system 130 sends an alert 460 to the first party that the time-based condition was not met. In some embodiments, the document management system 13 may further determine an action to take, based on the agreement, since the time-based condition was not met. For instance, the agreement may stipulate that the second party would receive their money back for shipping, so the document management system may automatically send a bill for the amount of money to the first party upon detecting that the triggering condition was not met.

Further, the agreement may stipulate that the pineapples may not experience a temperature above 100 degrees Fahrenheit during shipping. The document management system may receive real-time sensor data from a temperature sensor attached to the shipping container of the pineapples and determine that the time-based condition was not met if, before the amount of time 420 ends, the sensor data indicates a temperature of above 100 degrees. Alternatively, the document management system 130 may receive all of the sensor data from the amount of time after the pineapples arrive 440 at the warehouse and compare the sensor data to the threshold of 100 degrees Fahrenheit then.

In another example, the document management system 130 monitor movements of a truck relative to an agreement signed by a trucker with a shipping company. The agreement may indicate that the trucker has three days to transport a container from Park City to Saint Louis and must do so without exceeding a speed of 70 miles per hour. The document management system 130 may receive sensor data form a speedometer on the truck from when the agreement was signed until GPS coordinates, received from a GPS on the truck, indicate that the truck is in Saint Louis 2 days later. The document management system 130 determines that the truck did not exceed 70 miles per hour and the container was confirmed as delivered by a local warehouse, the document management system 130 may automatically allocate payment to the truck driver and notify the shipping company that the container was delivered. Though described extensively in relation to shipping throughout this disclosure, the document management system 130 described herein may be used for a range of suitable documents, events, and time-based conditions.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
inputting a document signed by one or more parties to a machine-learned model, the machine-learned model trained to identify one or more time-based conditions indicated in the document;
receiving one or more time-based conditions from the machine-learned model;
for each time-based condition:
identifying a respective database cataloging events corresponding to the time-based condition;
obtaining the event information; and
determining based on the event information whether the time-based condition has been met; and
for each time-based condition that has not been met, transmitting an alert to one or more of the one or more parties.

2. The method of claim 1, wherein the one or more databases include information describing signature information of the document and shipping updates related to the document.

3. The method of claim 1, further comprising:
accessing historical documents, wherein one or more portions of each historical document is labeled with an event; and
training the machine-learned model on the labeled historical documents.

4. The method of claim 1, wherein identifying the respective database further comprises:
identifying sensors associated with the document; and
receiving sensor data from each sensor as at least a portion of the event data.

5. The method of claim 4, wherein determining based on the event information whether the time-based condition has been met comprises:
comparing the sensor data to a threshold; and
responsive to determining the sensor data misaligns with the threshold, determining that the time-based condition has been met.

6. The method of claim 4, the sensors include one or more of a pressure sensor, a temperature sensor, a radio-frequency identification (RFID) sensor, an RFID tag, a light sensor, a humidity sensor, and a GPS.

7. The method of claim 4, wherein the sensor data for each sensor is associated with a time the sensor data was captured by the sensor, the method further comprising:
storing the event information with the associated time in one of the one or more databases.

8. The method of claim 1, further comprising:
retrieving one or more historical documents;
segmenting each historical document into a set of clauses;
transmitting the set of clauses to a client device for labeling by an external operator;
receiving, from the client device, a label for each of the set of clauses;
jittering each clause of the set of clauses to create one or more alternate clauses, each alternate clause labeled with the same label as the jittered clause; and
training the machine-learned model on the labeled clauses and alternate clauses.

9. A non-transitory computer-readable storage medium containing computer program code that, when executed by a processor, causes the processor to perform steps comprising:
inputting a document signed by one or more parties to a machine-learned model, the machine-learned model trained to identify one or more time-based conditions indicated in the document;
receiving one or more time-based conditions from the machine-learned model;
for each time-based condition:
identifying a respective database cataloging events corresponding to the time-based condition;
obtaining the event information; and
determining based on the event information whether the time-based condition has been met; and
for each time-based condition that has not been met, transmitting an alert to one or more of the one or more parties.

10. The non-transitory computer-readable storage medium of claim 9, wherein the one or more databases include information describing signature information of the document and shipping updates related to the document.

11. The non-transitory computer-readable storage medium of claim 9, further containing computer program code that causes the processor to perform steps comprising:
accessing historical documents, wherein one or more portions of each historical document is labeled with an event; and
training the machine-learned model on the labeled historical documents.

12. The non-transitory computer-readable storage medium of claim 9, wherein identifying the respective database further causes the processor to perform steps comprising:
identifying sensors associated with the document; and
receiving sensor data from each sensor as at least a portion of the event data.

13. The non-transitory computer-readable storage medium of claim 12, wherein determining based on the event information whether the time-based condition has been met further causes the processor to perform steps comprising:
comparing the sensor data to a threshold; and
responsive to determining the sensor data misaligns with the threshold, determining that the time-based condition has been met.

14. The non-transitory computer-readable storage medium of claim 12, the sensors include one or more of a pressure sensor, a temperature sensor, an RFID sensor, an RFID tag, a light sensor, a humidity sensor, and a GPS.

15. The non-transitory computer-readable storage medium of claim 12, wherein the sensor data for each sensor is associated with a time the sensor data was captured by the sensor and further containing computer program code that causes the processor to perform steps comprising:
storing the event information with the associated time in one of the one or more databases.

16. The non-transitory computer-readable storage medium of claim 9, further containing computer program code that causes the processor to perform steps comprising:
retrieving one or more historical documents;
segmenting each historical document into a set of clauses;
transmitting the set of clauses to a client device for labeling by an external operator;
receiving, from the client device, a label for each of the set of clauses;
jittering each clause of the set of clauses to create one or more alternate clauses, each alternate clause labeled with the same label as the jittered clause; and
training the machine-learned model on the labeled clauses and alternate clauses.

17. A system comprising:
one or more processors; and
a non-transitory computer-readable storage medium containing computer program code that, when executed by the one or more processors, causes the one or more processors to perform steps comprising:
inputting a document signed by one or more parties to a machine-learned model, the machine-learned model trained to identify one or more time-based conditions indicated in the document;
receiving one or more time-based conditions from the machine-learned model;
for each time-based condition:
identifying a respective database cataloging events corresponding to the time-based condition;
obtaining the event information; and
determining based on the event information whether the time-based condition has been met; and
for each time-based condition that has not been met, transmitting an alert to one or more of the one or more parties.

18. The system of claim 17, wherein the one or more databases include information describing signature information of the document and shipping updates related to the document.

19. The system of claim 17, the non-transitory computer-readable storage medium further containing computer program code that, when executed by the processor, causes the processor to perform steps comprising:
accessing historical documents, wherein one or more portions of each historical document is labeled with an event; and
training the machine-learned model on the labeled historical documents.

20. The system of claim 17, wherein identifying the respective database further causes the processor to perform steps comprising:
identifying sensors associated with the document; and
receiving sensor data from each sensor as at least a portion of the event data.
